(19) United States
(12) Patent Application Publication
(10) Pub. No.: US 2005/0119449 A1
(43) Pub. Date: Jun. 2, 2005

(54) Method for producing epoxidised polysulfides

(76) Inventors: Michael Zeitler, Alfter (DE); Nils Kottner, Greiz (DE); Manfred Bergfeld, Erlenbach-Mechenhard (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/513,896

(22) PCT Filed: May 22, 2003
(86) PCT No.: PCT/EP03/05341

(30) Foreign Application Priority Data
May 24, 2002 (DE) 102 23 283.0

(51) Int. Cl. C08G 75/04

(52) U.S. Cl. 528/375

(57) ABSTRACT

The invention relates to a method for producing polymer polysulfides comprising epoxy end groups, by reacting polysulfides comprising thiol end groups with epichlorohydrine in the presence of aqueous alkali lye. According to the invention, the polysulfide comprising thiol end groups is optionally dosed with aqueous soda lye into a recipient containing epichlorohydrine and optionally aqueous alkali lye, and the reaction mixture is finished. The inventive method is carried out in one step and has considerable advantages in terms of process technique. It especially enables savings to be made in terms of measuring and regulating techniques and enables energy to be saved. Furthermore, it is essentially risk-free and very environmentally friendly, and therefore enables pure products to be produced.

The invention relates to a method for the production of epoxidised polysulphides. Epoxidised polysulphides and methods for their production have long been known. Corresponding epoxidised polysulphides and their production are thus described, for example, in U.S. Pat. No. 2,731,437. In the case of the method disclosed there, a polysulphide comprising thiol end groups with very high molecular weights is first prepared from an organic dihalogenide and an inorganic polysulphide.

A dithiol with the formula
HS(CH₂CH₂OCH₂OCH₂CH₂ SS)ₙCH₂CH₂OCH₂OCH₂CH₂SH
with n=25 to 250 or higher
is thus formed for example from sodium polysulphide and dichloroethylformal (Cl CH₂ CH₂ OCH₂ OCH₂ CH₂ Cl).

This substance mixture, which is difficult to process, is then subjected to reductive S-S cleavage in order to achieve defined molecular weights that are sensible for the further processing into the epoxidised product. In the case of the use of dichloroethylformal, the SH-terminated polysulphides have an average molecular weight of approx. 168 to 4000 and have a viscosity of approx. 0.5 to 400 poise at room temperature.

These compounds, which can also be referred to as aliphatic saturated oxahydrocarbopolythio-polymercaptans, are the actual starting substances for the production of the epoxidised polysulphides claimed in U.S. Pat. No. 2,731,437.

The synthesis of epoxi-modified polysulphides takes place in two stages, whereby the polymer dithiol first reacts with epichlorohydrine with ring opening according to the following reaction equation.

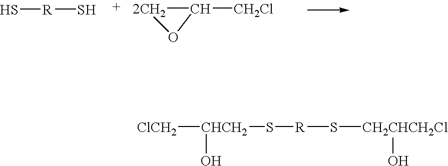

The added alkali hydroxide serves as a catalyst.

In the second stage, a renewed ring closure finally takes place with the separation of alkali chloride, whereby alkali chloride is consumed in a stoichiometric quantity according to the following reaction equation:

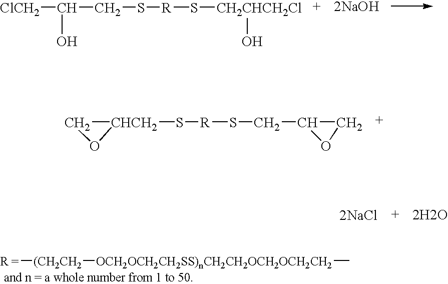

Since the reaction is strongly exothermic, it should be carried out according to the teaching of U.S. Pat. No. 2,731,437 in the presence of a diluent such as alcohol or ether.

The working-up of the reaction product then takes place as follows: the organic solvent (diluent) that has been used in the reaction is first distilled off together with any epichlorohydrine that may still be present. The residue is then taken up with another solvent non-miscible with water.

This organic solution is then washed (extracted) with water in order to remove alkali that is still present (unconsumed) and in particular the inorganic salts.

The solvent is then removed by distillation from this organic solution freed from inorganic constituents, and the desired end product, an epoxidised polysulphide, is obtained as a residue, in the case of the use of epichlorohydrine a glycidyl thioether of the polythiol used.

A similar method is described in U.S. Pat. No. 5,173,549 and the corresponding EP 0 347 131 B1, wherein the reaction of the polysulphide comprising mercapto end groups with epichlorohydrine is carried out in the absence of such solvents, which can form a single phase azeotropic mixture with the epichlorohydrine or with epichlorohydrine and water under the synthesis conditions.

Instead, epichlorohydrine is used in an excess (3.5 to 4 equivalents) related to the polysulphide and the reaction of the mercaptan with epichlorohydrine is started by adding alkali hydroxide drop by drop at temperatures around approx. 60° C. Likewise, the ring closure to form epoxide with the separation of alkali chloride also takes place at this temperature.

During the reaction, water or an azeotrop of water and epichlorohydrine is distilled off. After completion of the reaction, the residual epichlorohydrine is finally distilled off and the residue is taken up in work-up solvent, e.g. toluene.

This solution must then be filtered off from the organic salts and any alkali hydroxide that may still be present. A further distillation step for the separation of the work-up solvent (toluene) then follows.

A drawback with the two methods described in U.S. Pat. Nos. 2,731,437 and 5,173,549 is the fact that the reaction conditions for the synthesis taking place in two stages have to be controlled precisely in each case.

According to U.S. Pat. No. 2,731,437, the intensity of the first reaction stage thus has to be moderated by the addition of the diluent; the addition of alkali, which acts catalytically in the first stage, has to be precisely controlled and extends over a lengthy period. Furthermore, it is necessary to monitor the temperature control. This can take place, for example, by precise control of the metering of the alkali compound, but in addition there is usually also cooling of the reaction mixture in order to avoid an excessively large rise in temperature.

Even if the method according to U.S. Pat. No. 5,173,549 works without diluents to control the course of the exothermic reaction, this method is also unable to be carried out without control of the temperature in the first stage. Cooling has to be carried out; the addition of alkali has to be adjusted very precisely. According to example 4 of this patent specification, the solution of polysulphide in epichlorohydrine is even cooled with an ice bath before the start of the alkali addition. According to example 5, heating to 55° C. is carried out prior to the addition of alkali, but then cooling is carried out during the addition of alkali.

The expenditure with the methods according to the two U.S. patent specifications in the first stage of the synthesis is thus very high. In order to control this reaction, the requirements on the measuring and regulating techniques are very great. In addition, there is the fact that, with both methods, the second stage has to be carried out under different process conditions; thus, temperature control, alkali addition, pressure conditions etc. have to be changed over, which calls for further considerable expenditure on the measuring and regulating techniques. In addition, there is a risk with both types of method that, if the process conditions are not precisely adhered to, the reaction will run away, or in other words there will be a dangerous “run-away reaction” and the mixture will thus be lost or at the least will lead to products with poor properties.

Although a whole series of methods for the production of epoxidised polysulphides are already known, there is still a great need for an improved method of production, which in particular has a lower risk potential, takes place with less labour expenditure and works more economically, and which does not display the other drawbacks mentioned above.

The problem of the present invention is to make available a method for the production of epoxidised polysulphides, in which polysulphides comprising mercapto end groups, epichlorohydrine and alkali are reacted with one another, which works more reliably, more simply and more economically, is carried out with fewer process steps than the methods according to the prior art, and which in particular does not require the expenditure on measuring and regulating techniques that are required with the two-stage methods according to the prior art. Above all, the invention should make it possible to carry out the synthesis of epoxidised polysulphides as in a single-stage reaction, without an increased safety risk thereby arising.

This problem is solved by a method for the production of polymer polysulphides comprising epoxy end groups by reacting polysulphides comprising thiol end groups with epichlorohydrine in the presence of aqueous alkali lye, which is characterised in that epichlorohydrine is first introduced and the polysulphide comprising thiol end groups is added in a metered fashion, the reaction mixture then being worked up.

Aqueous alkali lye can either be introduced together with the epichlorohydrine or can preferably be metered into the initially introduced substance. In the latter case, care should be taken to ensure that the alkali lye is metered into the initially introduced substance at least in catalytic quantities or is present in the initially introduced substance in catalytic quantities, before the metering of the polysulphide starts.

It goes without saying that small quantities of polysulphide can also be added in a metered fashion before the metering of the alkali lye starts, or that the metering of the alkali lye and polysulphide can start simultaneously without this being at the cost of significant drawbacks.

It is however also possible to mix only catalytic quantities of aqueous alkali lye into the initially introduced substance with the epichlorohydrine and then to add the predominant quantity of alkali lye in a metered fashion in the course of the reaction. The aqueous alkali lye can obviously also be initially introduced into the reactor in quantities which are such that they lie between the catalytic quantity of alkali lye and the total quantity of alkali lye required for the reaction.

It is advantageous to use concentrated alkali lye as the alkali lye, in particular 30 to 60 wt. % alkali lye. Aqueous soda lye is particularly well suited for the method according to the invention.

The alkali lye is preferably used in stoichiometric quantities related to the polysulphide. It can, however, also be used in excess, preferably up to 20% above the stoichiometric quantity.

The reaction is preferably carried out whilst stirring.

It is advantageous to carry out the reaction in the presence of a phase transfer catalyst. Tertiary ammonium salts, in particular methyltrioctyl ammonium chloride, are preferred as phase transfer catalysts.

An advantageous form of embodiment of the method according to the invention consists in the fact that, for the working-up of the reaction mixture, the water is first largely removed, the organic phase present is separated from the precipitated salts and any alkali hydroxide that may still be present, and the epichlorohydrine is removed by distillation from the separated organic phase, whereby the polymer polysulphide comprising epoxy end groups is obtained as a residue, which is optionally then purified by distillation.

In order to work up the reaction mixture, it is possible, after the removal of the residual water still present in the reaction mixture, to filter off in a closed filter drier (rose-mouth filter) the precipitated alkali chloride and any alkali hydroxide that may still be present, and then to dry out, by means of a heated inert gas, the epichlorohydrine still adhering to the alkali chloride and alkali hydroxide.

It is however also possible, after removal of the residual water, to separate the essentially anhydrous organic phase by decanting or siphoning off from the precipitated salts and any alkali hydroxide that may still be present.

In contrast to the methods according to the prior art, in which the first stage has to be carried out whilst cooling at temperatures of approx. 20 to max. 50° C. and the second stage by heating at at least 40° C. to 90° C., the reaction with the method according to the invention can be carried out at the same temperature throughout the duration of the reaction. Preferred temperatures lie in the range from 35° to 50° C., whereby 40° C. is particularly preferred.

Other temperatures are also possible, but for economic reasons are not as advantageous.

The purification of the polymer polysulphide comprising epoxy end groups preferably takes place by means of thin-layer distillation. It is advantageous to carry out the thin-layer distillation with the addition of an agent forming an azeotrop with epichlorohydrine, in particular n- or iso-propanol.

A further form of embodiment of the method according to the invention can also consist in the fact that water and epichlorohydrine and any other volatile constituents that may be present are distilled off from the reaction mixture, the polysulphide comprising epoxy end groups found in the residue is taken up in a solvent (work-up solvent), the polysulphide comprising epoxy end groups is separated from the solution obtained and purification is optionally carried out by distillation.

To advantage, the work-up solution is extracted with water in order to remove inorganic salts and alkali hydroxide. As a work-up solvent, use is made of a solvent in which inorganic salts and alkali hydroxide are largely insoluble.

The method according to the invention can for example be carried out as follows:

An initially introduced substance of epichlorohydrine and optionally aqueous alkali lye is first prepared. This can take place, for example, in such a way that the epichlorohydrine is first placed in a vessel, then the whole of the alkali lye is added and the two constituents mixed together.

The quantity of epichlorohydrine used depends on the quantity of polysulphide comprising thiol end groups that is to be introduced into the reaction. Generally, it is expedient to use a two- to twelve-fold, preferably three- to ten-fold, in particular four- to eight-fold molecular excess of epichlorohydrine.

The initially introduced substance can contain further additives, in particular a phase transfer catalyst.

It is also possible to mix other additives into the initially introduced substance, such as for example alcohol or ether. Preferably, however, the initially introduced substance contains only epichlorohydrine and optionally alkali hydroxide in the form of aqueous alkali lye and also, if need be, the phase transfer catalyst.

The distilling-off of water as an azeotropic mixture together with epichlorohydrine starts immediately with the commencement of the metered addition of the polysulphide. Reaction heat is liberated during the metered addition of the polysulphide, said reaction heat on the one hand being extracted again from the system in the form of evaporation heat during the distilling-off of the water/epichlorohydrine azeotrop and on the other hand being used for the ring closure reaction.

To complete the reaction, it may be necessary to supply heat to the system from the exterior.

After completion of the reaction and after all the water has been distilled off (i.e. the water originating from the initially introduced aqueous soda lye and the water liberated in the reaction), a mixture is present which contains epichlorohydrine, the reaction product as well as inorganic salts and, as the case may be, alkali.

The working-up of this mixture can take place, for example, according to a method such as that described in U.S. Pat. No. 2,731,437. Namely, the epichlorohydrine is first distilled off, after which the residue is taken up with another solvent non-miscible with water.

Toluene or methylisobutyl ketone is preferably used as a solvent, which here has the function of a work-up solvent. Further suitable solvents are cyclohexanone, butyl acetate, benzene, xylene, carbon tetrachloride, ethylene dichloride, chlorobenzene, dibutyl ether and suchlike.

This organic solution is then washed with water in order to remove alkali (unconsumed) still present as well as inorganic salts. The solvent is then removed by distillation from this organic solution freed from inorganic constituents, and the desired end product, an oxidised polysulphide, is obtained as a residue.

Preferably, however, the separation of the inorganic salts and any residual alkali that may still be present is carried out directly, either by means of filtration or by decanting or siphoning off.

For this purpose, the reaction mixture, which now essentially consists of epichlorohydrine, alkali and inorganic salts and the epoxidised polysulphide, is cooled, preferably to room temperature, and left to stand for a time. The inorganic constituents are thereby deposited in largely crystalline form at the bottom and edge of the vessel. The organic phase can then be separated by decanting or siphoning off the inorganic constituents.

The organic phase is then freed from epichlorohydrine by distillation, the desired end product, epoxidised polysulphide, being precipitated as a residue, which if necessary can further be purified, preferably by means of thin-layer distillation.

It was particularly surprising that it was possible, by means of the invention, to dispense with a whole series of process steps that were necessary according to the prior art. The reaction is thus carried out, as it were, as a single-stage reaction, i.e. there is no longer any need, as in the past, to make a distinction between the first and the second stage, so that different temperature controls and costly heating and cooling can be dispensed with. Furthermore, the polysulphide comprising mercaptan end groups that is to be reacted can be constantly added in a metered fashion. The costly metered addition of alkali lye is dispensed with, which according to the prior art had to be carried out carefully and in small quantities in the first stage. A change in the metering does not therefore need to take place for the second stage.

This signifies an enormous advance in process technology, in particular a simplification and a significant saving on energy which occurs with the metering of the polysulphide; the yield related to epichlorohydrine and the purity of the end product are not thereby adversely affected.

Above all, it is a complete surprise that there is virtually no further reaction of the epoxy end groups with an excess of alkali hydroxide under the selected conditions, amongst other things with raised temperatures. That is to say that the quality of the product obtained is excellent.

The end product is characterised by a high degree of purity. Since the quality of the product obtained is excellent, it is also very well suited for further processing, for example for the production of adhesives, coatings, sealants and suchlike.

The invention will be explained in greater detail with the following examples.

### EXAMPLE 1

150 kg of epichlorohydrine is initially introduced into a 500 l double-jacket glass reactor (firm: Schott, Mainz), equipped with an anchor agitator, distillation attachment, phase separator, bottom drain valve and metering device, the glass reactor is cooled with spring water, and 80 kg of aqueous 25% soda lye is mixed in carefully whilst stirring. The reactor is then heated to 40° C., a vacuum of 50 mbar is applied and 220 kg of a polymer polysulphide heated to 40° C. (Thioplast G4, Mw approx. 1100) is added continuously in a metered fashion by means of a reciprocating pump in the presence of vigorous stirring. An azeotropic mixture of water/epichlorohydrine is distilled off via the distillation attachment throughout the metering period and is separated in the phase separator into a lighter water phase and a heavier epichlorohydrine phase. The latter is continuously fed back into the reactor. After 90 minutes, the total quantity of polysulphide has been added in a metered fashion and the reaction is virtually finished. Heating at 70° C. is carried out for a further 30 minutes to complete the reaction with an adjustment of the vacuum, whereby the recirculation of the epichlorohydrine phase from the phase separator is ended and the residual water is removed by distillation, which can be detected by the fact that, in the end, the temperature in the distillation attachment rises to the boiling point of pure epichlorohydrine.

The reactor contents are cooled to 20° C. in order to complete the crystallising-out of the cooking salt and the excess NaOH. The stirring apparatus is switched off, and after 12 hours the solution is removed by decanting from the separated crystals. The solution containing the reaction product is then largely freed from epichlorohydrine within 2 hours by distillation at a pressure of 25 mbar and with a temperature regime of 30-80° C.

In order to remove the traces of epichlorohydrine still present, the slightly viscous polymer is purified via a two-stage thin-layer evaporator from the firm Fischer, Meckenheim, with a total area of 0.45 m² at a pressure of 0.1-2 mbar. The yield related to the Thioplast used is 98.5%; the product is obtained as a clear, bright-yellow low-viscous (2 Pa·s) liquid with a residual content of less than 100 ppm of epichlorohydrine.

### EXAMPLE 2

In the same test arrangement as an example 1, 165 kg of epichlorohydrine is carefully mixed with 2.5 kg of 50 wt. % soda lye and 250 g of Aliquate 336 whilst stirring, whereby the temperature is held at room temperature. The initially introduced mixture is then heated to 55° C. and a total of 210 kg of Thioplast G4 and 42.5 kg of 50 wt. % soda lye is added in a metered fashion over a period of 120 minutes. The applied vacuum is then selected such that, throughout the whole metering period, an azeotropic mixture of water and epichlorohydrine is continuously taken up via the distillation attachment and the heavier epichlorohydrine phase is continuously sluiced back into the reactor after the phase separation. During the metered addition of the Thioplast G4 and the soda lye, only a small supply of heat is necessary, since the energy required for the evaporation is largely provided by the reaction heat liberated during the metered addition of the Thioplast G4 solution. The pressure is held between 50 and 200 mbar.

After the completed reaction, which is indicated by an increase in the temperature in the distillation attachment to the boiling temperature of pure epichlorohydrine, all the epichlorohydrine is completely removed by applying a full vacuum and a maximum temperature of 65° C. The residue evaporated to dry is then stirred with 115 l of toluene over a period of approx. 30 minutes and after settling is decanted off via an immersion tube, which is provided with a metal sintering plate in order to retain fine salt particles. The clear toluene solution resulting therefrom is transferred into a separate 500 l reactor and is completely freed from toluene at 40 mbar and a final temperature of 100° C.

The slightly viscous residue is purified via a two-stage thin-layer evaporator from the firm Fischer, Meckenheim, with a total area of 0.45 m² at a pressure of 0.1 to 2 mbar. The yield related to the Thioplast used is 98.5%; the product is obtained as a clear, bright-yellow low-viscous liquid (2 Pa·s).

### EXAMPLE 3

In the same test arrangement as an example 1, 111 kg of epichlorohydrine (1.2 Kmol) is carefully mixed with 23.6 kg of 50 wt. % aqueous soda lye and 22.8 kg of ethanol in the presence of cooling and intensive stirring. The mixture is then heated to 50° C. and 120 kg of a liquid Thioplast (average molecular weight 600) from the firm AKCROS Chemicals Greiz is added in a metered fashion over a period of 120 minutes analogous to example 1, but without the application of a vacuum. The whole quantity of Thioplast is then added in a metered fashion, post-reacted for approx. 30 min. at 65° C. and then the whole reactor contents are reduced to dry under vacuum at 20 mbar and at max. 65° C. whilst stirring.

The reactor contents are then mixed with 350 l of toluene whilst stirring and the mixture formed is continuously extracted with water in a pulsing sieve-bottom column in order to remove the inorganic constituents. The extracted toluene solution is then worked up analogous to example 2.

A total of 185 kg of a viscous, light-yellow product is obtained as a residue, which can be used directly for the production of sealants etc.

1-19. (canceled)

20. A method for the production of polymer polysulphides comprising epoxy end groups by reacting polysulphides comprising thiol end groups with epichlorohydrine in the presence of aqueous alkali lye, characterized in that epichlorohydrine is initially introduced and the polysulphide comprising thiol end groups is added in a metered fashion and then the reaction mixture is worked up.

21. A method according to claim 20, characterized in that aqueous alkali lye is also metered into the initially introduced substance.

22. A method according to claim 20, characterized in that catalytic quantities of alkali lye are added to the initially introduced substance prior to the start of the polysulphide metering.

23. A method according to claim 20, characterized in that the total quantity of alkali lye is introduced before the start of the polysulphide metering.

24. A method according to claim 20, characterized in that 30 to 60 wt. % concentrated alkali lye is used.

25. A method according to claim 20, characterized in that soda lye is used as aqueous alkali lye.

26. A method according to claim 20, characterized in that the alkali lye is used in a stoichiometric excess.

27. A method according to claim 26, characterized in that the amount of alkali lye used is no greater than 20% above a stoichiometric quantity.

28. A method according to claim 20, characterized in that the reaction is carried out in the presence of a phase transfer catalyst.

29. A method according to claim 28, characterized in that the phase transfer catalyst is a tertiary ammonium salt.

30. A method according to claim 29, characterized in that methyltrioctyl ammonium chloride is used as the catalyst.

31. A method according to claim 20, characterized in that the reaction is carried out whilst stirring.

32. A method according to claim 20, characterized in that, for the working-up of the reaction mixture, water is first removed and then the organic phase present is separated from the precipitated salts and any alkali hydroxide that is still present and the epichlorohydrine is removed by distillation from the separated organic phase, whereby the polymer polysulphide comprising epoxy end groups is obtained as a residue.

33. A method according to claim 32, characterized in that the polymer polysulphide comprising epoxy end group is further purified by distilation.

34. A method according to claim 32, characterized in that, for the working-up of the reaction mixture after the removal of the residual water still present in the reaction mixture, the reaction mixture is filtered off in a closed filter from precipitated alkali chloride and any alkali hydroxide that is still present and then the epichlorohydrine still adhering to the alkali chloride and alkali hydroxide is dried out by means of a heated inert gas.

35. A method according to claim 32, characterized in that, after the removal of the residual water, the essentially anhydrous organic phase is separated by decanting or siphoning off from the precipitated salts and any alkali hydroxide that is still present.

36. A method according to claim 20, characterized in that the polymer polysulphide comprising epoxy end groups is purified by means of thin-layer distillation.

37. A method according to claim 36, characterized in that the thin-layer distillation is carried out with the addition of an agent forming an azeotrop with epichlorohydrine.

38. A method according to claim 37, characterized in that the agent is n-propanol or iso-propanol.

39. A method according to claim 20, characterized in that water, epichlorohydrine, and any other volatile constituents that are still present are distilled off from the reaction mixture, the polysulphide comprising epoxy end groups present in the residue is picked up in a solvent, and the polysulphide comprising epoxy end groups is separated from the solution obtained.

40. A method according to claim 39, characterized in that the polysulphide comprising epoxy end groups is further purified by distillation.

41. A method according to claim 39, characterized in that the work-up solution obtained after the taking-up is extracted with water in order to remove inorganic salts and alkali hydroxide.

42. A method according to claim 39, characterized in that a work-up solvent is used, in which inorganic salts and alkali hydroxide are almost completely insoluble.

43. A method according to claim 39, characterized in that the polysulphide comprising epoxy end groups dissolved in the work-up solvent is separated by filtration from the inorganic salts.
